(19) United States
(12) Patent Application Publication
(10) Pub. No.: US 2021/0026275 A1
(43) Pub. Date: Jan. 28, 2021

(54) ADJUSTABLE PRINT SUBSTANCE CONTAINERS

(71) Applicant: HEWLETT-PACKARD DEVELOPMENT COMPANY, L.P., Spring, TX (US)

(72) Inventors: Dean RICHTSMEIER, Boise, ID (US); Brian C. MAYER, Boise, ID (US)

(73) Assignee: HEWLETT-PACKARD DEVELOPMENT COMPANY, L.P., Spring, TX (US)

(21) Appl. No.: 17/043,334

(22) PCT Filed: Jun. 8, 2018
(86) PCT No.: PCT/US2018/036604

§ 371 Date: Sep. 29, 2020

(51) Int. Cl. G03G 15/08

(52) U.S. Cl. CPC G03G 15/0868; G03G 15/0855; G03G 15/0879

(57) ABSTRACT

In some examples an adjustable print substance container may include a housing, a piston disposed in the housing to translate relative to the housing, a stop coupled to the housing or the piston, markings disposed on the housing or the piston coupled to the stop, where the markings corresponding to a plurality of a total number of pages, and an adjustable stop coupled to the other of the housing or the piston, the adjustable stop being adjustable to selectively permit an amount of translation of the piston relative to the housing, the amount of translation being equal to a respective total number of pages of the plurality of the total number of pages.

### CROSS REFERENCE TO RELATED APPLICATION

This application is a U.S. National Stage Application which claims the benefit under 35 U.S.C. § 371 of International Patent Application No. PCT/US2018/036604 filed on Jun. 8, 2018, the contents of which are incorporated herein by reference.

### BACKGROUND

Imaging systems such as printers, copiers, etc. may be used to form markings on a physical medium, such as text, images, etc. Imaging systems may form markings on the physical medium and/or form a three-dimensional object by employing a print substance such as an ink, toner, and/or a three-dimensional printing substance such as three-dimensional printing powders, etc.

### BRIEF DESCRIPTION OF THE DRAWINGS

FIG. 1 illustrates an example of an adjustable print substance container consistent with the disclosure.

FIG. 2 illustrates another example of an adjustable print substance container consistent with the disclosure.

FIG. 3 illustrates yet another example of an adjustable print substance container consistent with the disclosure.

FIG. 4 illustrates still another example of an adjustable print substance container consistent with the disclosure.

FIG. 5 illustrates a block diagram of a system including an adjustable print substance container and an imaging device consistent with the disclosure.

### DETAILED DESCRIPTION

Imaging devices may include an amount of a print substance in a reservoir. As used herein, the term “reservoir” refers to a container, a tank, and/or a similar vessel having a volume to store an amount of print substance for use by an imaging device. As used herein, the term “imaging device” refers to a hardware device with functionalities to physically produce representation(s) of text, images, models, etc. on a physical medium and/or produce a three-dimensional object. Examples of imaging devices include ink/toner printers and/or three-dimensional printers, among other types of imaging devices.

An imaging device may use a print substance in the reservoir to create text, images, etc. on a physical medium and/or create a three-dimensional object. However, the reservoir may have a finite amount of print substance in a volume of the reservoir at a given time. The amount of print substance in the reservoir may be reduced during operation of the imaging device, for instance, due to application of print substance from the reservoir to a physical medium and/or otherwise provided to create an object such as three-dimensional object. At some point, an amount of print substance in the reservoir may be less than a threshold amount of print substance for the imaging device to operate as intended.

As such, the reservoir may be filled/refilled to provide/maintain an amount of print substance in the reservoir that is greater than the threshold amount of print substance. For instance, some approaches may employ a print substance container. As used herein, the term “print substance container” may refer to a vessel, bottle, bag, box, carton, or other suitable receptacle for the transfer and/or containment of a print substance from the print substance container to the imaging device.

However, components of an imaging device (e.g., a print cartridge) may have a finite useful life. An imaging device may not function as intended after a component in the imaging device reaches and/or exceeds its useful life. Yet some approaches/print substance containers may not provide an ability to control an amount of print substance added to a reservoir. As a result, not having an ability to control an amount of print substance added to a reservoir may lead to some print substance being wasted if the amount of print substance added to the reservoir exceeds an amount utilizable during a useful lifetime of a component.

Accordingly, the disclosure is directed to adjustable print substance containers. For example, an adjustable print substance container may include a housing, a piston disposed in the housing to translate relative to the housing, a stop coupled to the housing or the piston, markings disposed on the housing or the piston coupled to the stop, where the markings correspond to a plurality of a total number of pages, and an adjustable stop coupled to the other of the housing or the piston. Notably, the adjustable stop may be adjustable to selectively permit an amount of translation of the piston relative to the housing. For instance, the amount of translation may be equal to a respective total number of pages of the plurality of the total number of pages. That is, adjustable print substance containers may permit addition of a respective total number of pages worth of print substance to a reservoir of an imaging device to prevent excess print substance from being added, among other possibilities.

In some examples, a respective total number of pages worth of print substance may be based on an estimated remaining useful lifetime of a component of an imaging device, client obligations, and/or contractual obligations, among other possibilities. The respective total number of pages worth of print substance may be based on a remaining lifetime of a component such as a cartridge and/or a pump of an imaging device. For example, if a component has an estimated remaining useful lifetime equal to a given number of pages (e.g., approximately 300 pages worth of print substance) then that number of pages (or less) of print substance may be added to a reservoir of the imaging device to prevent excess print substance (e.g., more than 300 pages worth of print substance) from being added, among other possibilities.

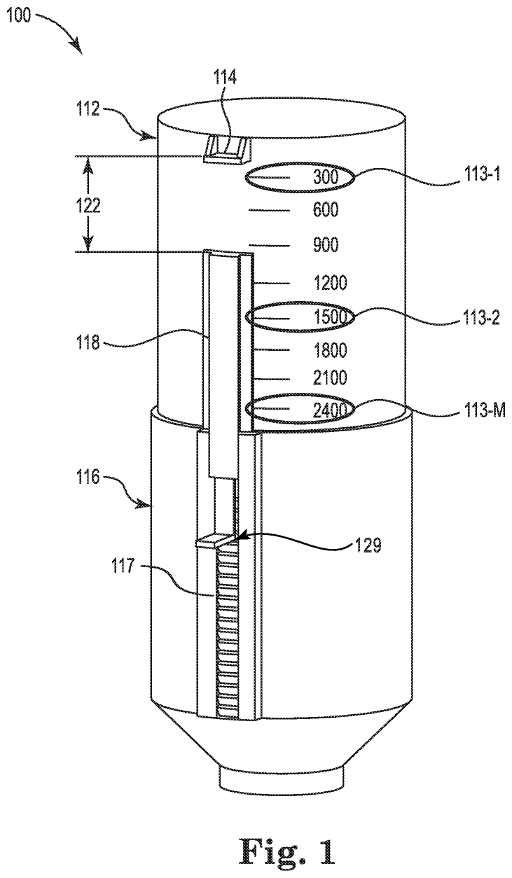

FIG. 1 illustrates an example of an adjustable print substance container 100 consistent with the disclosure. As used herein, the term “adjustable print substance container” refers to a print substance container including an adjustable stop, as detailed herein. As mentioned, examples of a print substance include ink, toner, and/or three-dimensional printing substances such as print powders. That is, in some examples, adjustable print substance containers may include toner and/or a three-dimensional printing powder.

As illustrated in FIG. 1, the adjustable print substance container 100 may include a piston 112 and a housing 116. As used herein the term “housing” refers to a casing that encloses at least a portion of another component such as a piston. As used herein, the term “piston” refers to a disk and/or cylinder, or other shape fitting closely within the housing 116 in which the piston moves against a liquid and/or gas to impart motion into the liquid and/or gas. For instance, as detailed herein, the piston 112 may translate to impart motion into a print substance in a volume of the housing 116. While FIG. 1 illustrates the housing 116 and the piston 112 as cylindrical in shape, the housing 116 and/or piston 112 may be other shapes.

As illustrated in FIG. 1, the piston 112 may include markings 113-1, 113-2, . . . , 113-M (collectively referred to herein as “markings 113). In various examples, the markings 113 correspond to a plurality of a total number of pages. In some examples, the markings 113 may include a sequential total number of pages such as an increasing and/or decreasing sequence of pages.

For instance, as illustrated in FIG. 1, a first marking 113-1 may correspond a first value (e.g., 300 pages), a second marking 113-2 may correspond to a second value (e.g., 1500 pages), and a third marking 113-M may correspond to a third value (e.g., 2400 pages). That is, a respective total number of the pages corresponds to an approximate volume of print substance utilizable by an imaging device to generate the respective total number of the pages. For instance, as illustrated in FIG. 1, the adjustable stop is positioned to permit an amount of translation 122 that equates to an approximate volume of print substance utilizable by an imaging device to generate 900 total number of the pages.

As used herein, “an approximate volume of print substance utilizable by an imaging device to generate the respective total number of the pages” refers to a volume of print substance within a given range of the total number of the pages. For instance, an approximate volume of print substance utilizable by an imaging device to generate the respective total number of the pages may refer to a range relative to a selected total number of pages of +/−5 pages, 10 pages, 25, pages, 50 pages, 100 pages, 200 pages, 500 pages, and/or 1000 pages relative to the total number of pages, among other possible values.

For instance, selection of a mark corresponding to 900 total pages may result in an amount of print substance to generate a total amount of pages in a range from 850 pages to 950 pages, among other values and/or ranges. A value of a range may depend upon various factors such as a value of the total number of pages, a type of imaging device, and/or content (pictures, text, etc.) of the pages, among other factors. For instance, selection of a higher total number of pages (e.g., 900 total pages) may result in a greater range (e.g., 850 pages to 950 pages) versus a range (e.g., 90 pages to 110 pages) associated with selection of a lower total number of pages (e.g., 100 pages).

In some examples, the markings 113 may be included on the housing 116. For instance, in some examples the markings 113 may be included on the housing 116 and omitted from the piston 112. In some examples, the markings 113 may be included on the housing 116 coupled to the stop. However, in some examples the markings 113 may be included on the piston 112 when the stop 114 is coupled to the piston 112.

In some examples, additional markings (not shown for ease of illustration) may be included on the housing 116, the piston 112, and the adjustable stop 118 to convey a number of pages worth of print substance remaining in the adjustable print substance container 100. For instance, additional markings may be included on the adjustable stop 118 to provide an amount of print substance remaining in the adjustable print substance container 100 as the adjustable stop is translated relative to the housing 116 and markings 113 on the piston 112. In such examples, the additional markings may be an ordered set of sequentially decreasing values relative to the order set of sequentially increasing values (e.g., 300, 600, . . . , 2400 pages) on the piston 112. Thus, the marking 113 and the additional markings may readily convey both a remaining total number of print substance included in the adjustable print substance container 100. However, in some examples, adjustable print substance containers herein may include a plurality of markings corresponding to particular volume (e.g., cubic centimeters) of print substance.

The stop 114 refers to a notch, bump, ring, and/or other projection that projects from a surface of the piston 112 and/or the housing 116. For instance, as illustrated in FIG. 1 to stop may be included on the piston 112. In such examples, the markings 113 may be included on the piston 112. However, the disclosure is not so limited. Rather the stop 114 may be included on the housing 116. For instance, in some examples the stop 114 may be included on the housing 116 and omitted from the piston 112, among other possibilities to promote aspects of adjustable print substance containers. That is, both the stop 114 and adjustable stop 118 may be oriented opposite of each other either on the housing 116 or the piston 112, respectively.

The housing 116 and the piston 112 may be removably or non-removably coupled together. For instance, the housing 116 and the piston 112 may be removably coupled to permit decoupling of the housing 116 (with or without a tool) and thereby permit filling a volume of the housing 116 with an amount of print substance. However, in some examples, the housing 116 and the piston 112 may be non-removably coupled together (i.e., designed to remain coupled together) to prevent or limit an ability of the volume of the housing 116 and/or the piston 112 to be refilled with a print substance once the housing 116 and the piston 112 are non-removably coupled together.

The housing 116 may be formed of a plastic, metal, rubber, and/or combinations thereof, among other suitable materials. Similarly, the piston 112, the stop 114, the notches 117, and the adjustable stop 118 may be formed of a plastic, metal, rubber, and/or combinations thereof, among other suitable materials. The housing 116, the piston 112, the stop 114, the notches 117, and the adjustable stop 118 and/or other components of adjustable print substance containers as described herein may be formed of a same or a different material.

As illustrated in FIG. 1, the housing 116 may include notches 117. In some examples, the notches 117 may be sized to provide a particular incremental change in a total number of pages from a first notch to a second notch adjacent to the first notch. Stated differently, each notch of the notches 117 may have a uniform size to provide a particular incremental change in a total number of pages. Examples of suitable amounts of incremental changes include 10 pages, 50 pages, 100 pages, 200 pages, 500 pages, 1000 pages, among other possible total numbers of pages. For example, a first notch may provide approximately 300 total pages worth of print substance while a second notch adjacent to the first notch may provide 400 total pages worth of print substance, among other possibilities.

As illustrated in FIG. 1, the adjustable stop 118 may be an elongated member. The adjustable stop 118 may include an interface 129 on the elongated member. In this manner, the interface 129 may be disposed in a particular notch of the notches 117 to selectively permit an amount of translation 122 of the piston 112 relative to the housing 116.

For instance, as illustrated in FIG. 1 the interface 129 may be disposed in a notch to permit an amount of translation 122 of the piston 112 relative to the housing 116 to provide a respective total number of pages that is equal to 900 total pages worth of print substance. That is, when the adjustable stop is adjusted as illustrated in FIG. 1 actuation of the piston 116 from the first position illustrated in FIG. 1 to a second position when the stop 114 contacts the adjustable stop 118 results in 900 total pages worth of print substance being dispensed via an opening (as described herein) from the adjustable print substance container 100. However, it is understood that selection and dispensing different amounts of print substance worth differing total numbers of pages is possible.

While the notches 117 in FIG. 1 are illustrated on an exterior surface of the housing 116, the notches 117 may be disposed in a different location and/or in an additional location such as internally between an interface (not shown) of the housing 116 and the piston 112. For instance, the adjustable stop 118 may include notches analogous or similar to the notches illustrated in FIG. 1 while in such examples an interface (similar to interface 129) may be disposed on an exterior surface of the housing 116.

That is, the adjustable stop 118 and/or other adjustable stops as detailed herein may permit a given amount of translation 122 of the piston 112 relative to the housing 116 to dispense some or all of an amount of print substance in the adjustable print substance container 100. As used herein, the term “adjustable stop” refers to hardware to be adjustable towards a predetermined position corresponding to an approximate amount of print substance utilizable by an imaging device to generate a respective total number of pages of a print job. Examples of adjustable stops include adjustable hardware members which may utilize grooves, a screw, threads, notches, and/or rings, among other types of hardware to provide an adjustable stop such as the adjustable stops detailed herein. The adjustable stop 118 may translate either in the upward or downward direction.

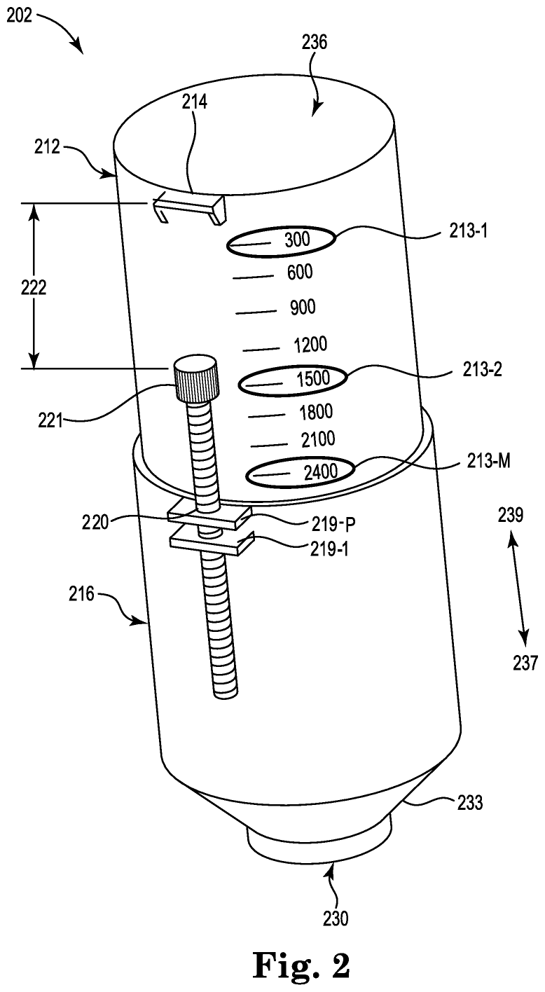

FIG. 2 illustrates another example of an adjustable print substance container 202 consistent with the disclosure. Piston 212 is analogous or similar to piston 112, 312, and/or 412 of FIGS. 1, 3, and 4, respectively. Markings (213-1, 213-2, . . . , 213-M) are analogous or similar to markings (113-1, 113-2, . . . , 113-M), (313-1, 313-2, . . . , 313-M), and/or (413-1, 413-2, . . . , 413-M of FIGS. 1, 3, and 4), respectively. Stop 214 is analogous or similar to stop 114, 314, and/or 414 as illustrated in FIGS. 1, 3 and 4, respectively. Housing 216 is analogous or similar to housing 116, 316, and/or 416 as illustrated FIGS. 1, 3 and 4, respectively. The amount of translation 222 is analogous or similar to an amount of translation 122, 322 and/or 422 as illustrated in FIGS. 1, 3 and 4, respectively.

As illustrated in FIG. 2, the adjustable print substance container 202 may include a housing 216 including brackets 219-1, . . . 219-P (collectively referred to herein as brackets 219). As used herein, a bracket refers to a projection extending away from an exterior surface of the piston 212 and/or the housing 216. While a total of two brackets are illustrated in FIG. 2, the adjustable print substance container 202 may include more brackets or fewer brackets.

As illustrated in FIG. 2, the brackets 219 may include respective openings such as opening 220 passing through the bracket 219-P. An interior surface of the respective openings includes a threaded surface (not shown for ease of illustration). In such examples, an adjustable stop may include a rotatable adjustable stop 221 to rotate in the threaded surface of the respective openings to translate along a portion of a length of the housing 216 in a downward direction 237 and/or in an upward direction 239.

For instance, in some examples the stop 214 may be positioned relative to the adjustable stop to limit an amount of downward translation of the piston 212 relative to the housing 216. Limiting the amount of downward translation may permit some but not all of a print substance (e.g., a three-dimensional printing powder) in the adjustable print substance container 202 from being emitted at a given time. Therefore, limiting the amount of downward translation may permit a plurality of instances of emission of printing substance from the volume 236 and/or permit selective emission of a particular number of pages worth of printing substance from the volume.

For instance, such translation to a given thread in the threaded surface may permit a selective amount of translation of the piston 212 relative to the housing 216. For instance, as illustrated in FIG. 2, the piston 212 may translate relative to the housing 216 in an amount of translation being equal to approximately 1200 pages, among other possibilities. That is, an amount of printing substance contained in a volume 226 of the adjustable print substance container may be displaced by translation of the piston 212 relative to the housing 216.

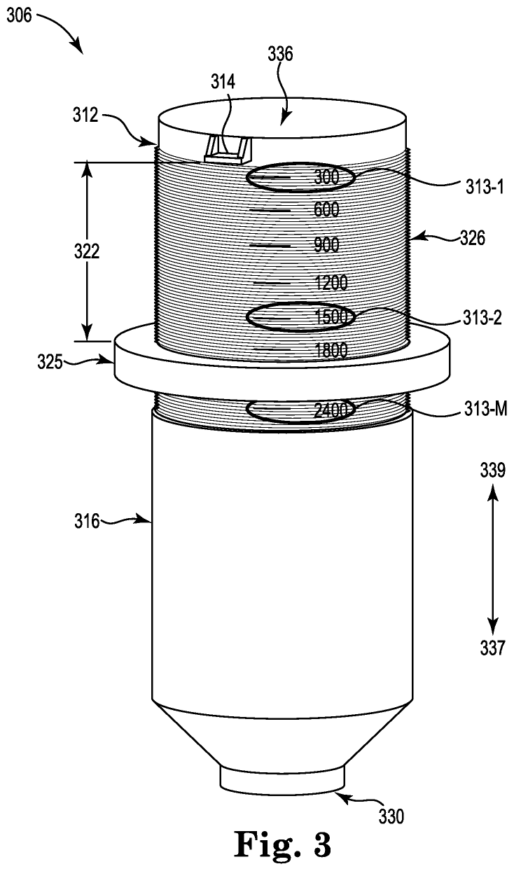

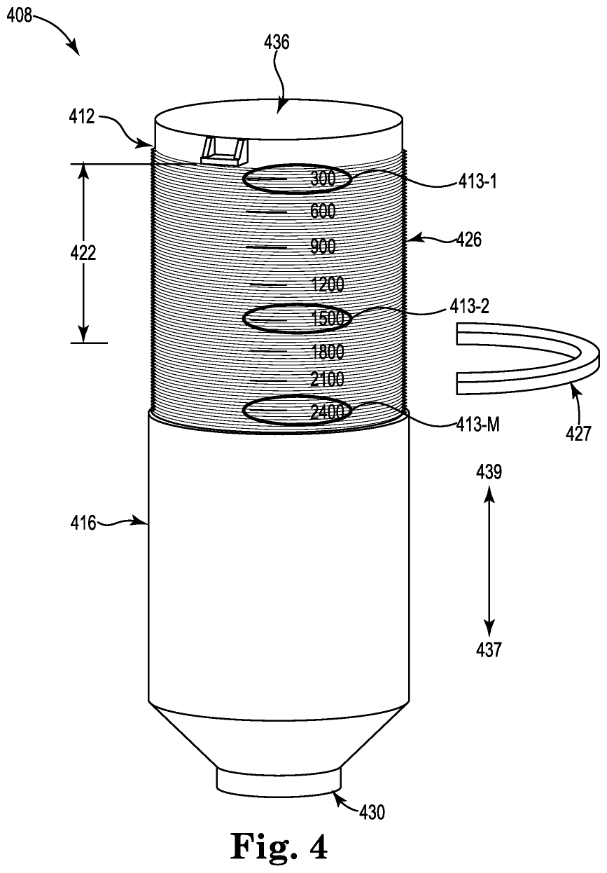

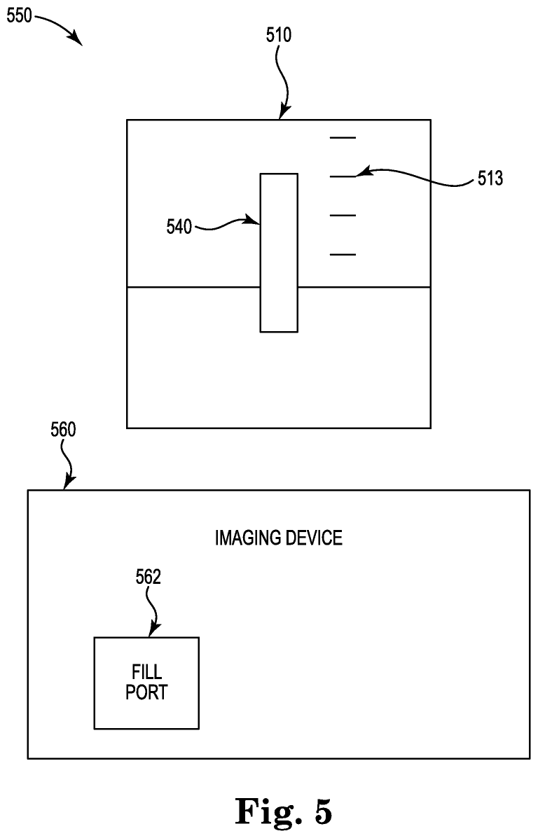

For instance, an amount of print substance may be emitted from nozzle 230. The nozzle 230 may be in fluidic communication with the volume 236 defined by the housing 216 and/or the piston 212. The nozzle 230 may be an opening defined by the housing 216 that extends from an environment (e.g., environment 564 as illustrated in FIG. 5) external to the adjustable print substance container 202 into the volume 236 of the print substance container. For instance, as illustrated in FIG. 2, the nozzle may be located at a first distal end 236 of the adjustable print substance container, among other possible locations. The nozzle 230 may be analogous or similar to nozzle 330 and/or 430 as illustrated herein with respect to FIGS. 3 and 4, respectively. The volume 226 may be analogous or similar to volume 336 and/or 436 as illustrated in FIGS. 3 and 4, respectively.

In some examples the adjustable stop may be a rotatable adjustable stop. For instance, as illustrated in FIG. 2 displays a rotatable adjustable stop 221 that can be rotated and adjustably coupled to the housing 216 via the brackets 219. While FIG. 2 displays the rotatable adjustable stop 221 as a screw, it is not so limited and may include a bolt, rod and/or pin, among other types of rotatable adjustable stops. As illustrated in FIG. 2, the stop 214 may be located at a second distal end 238 of the adjustable print substance container 202 opposite the first distal end of the adjustable print substance container 202, among other possibilities.

FIG. 3 illustrates yet another example of an adjustable print substance container 306 consistent with the disclosure. The adjustable print substance container 306 may include a piston 312 and a housing 316, as described herein.

In some examples, the piston 312 may include a threaded exterior surface 326, as illustrated in FIG. 3. In such examples, the adjustable stop may be a nut 325 including corresponding threads to couple to the threaded exterior surface 326. The nut 325 may rotate and translate the nut relative to the piston 312 and/or the housing 316. For instance, the nut 325 may rotate in the threads of the threaded exterior surface 326 to translate along a portion of a length of the piston 312 in a downward direction 337 and/or in an upward direction 339. As discussed, such translation to a given thread in the threaded exterior surface 326 may permit a selective amount of translation of the piston 312 relative to the housing 316. For instance, as illustrated in FIG. 3, the piston 312 may translate relative to the housing 316 in an amount of translation being equal to approximately 1800 pages, among other possibilities.

FIG. 4 illustrates still another example of an adjustable print substance container 408 consistent with the disclosure. The adjustable print substance container 408 may include a piston 412 and a housing 416, as described herein.

In some examples, the piston 412 may include a threaded exterior surface 426, as illustrated in FIG. 4. The threaded exterior surface may be analogous or similar to threaded exterior surface 326 as described herein with respect to FIG. 3. In such examples, the adjustable stop may be a fastener 427 to couple to a thread of the threaded exterior surface 426. As used herein, the term “fastener” refers to a mechanism having a mechanical device that is sized and/or includes a mechanism to couple to another surface such as a threaded surface. For instance, the fastener 427 may be coupled to a thread to permit an amount of translation by the piston in a downward direction 437 and/or in an upward direction 439. As a result, the piston 412 may translate relative to the housing 416 in an amount of translation being equal to approximately 1800 pages, among other possibilities.

FIG. 5 illustrates a block diagram of a system 550 including an adjustable print substance container 510 and an imaging device 560 consistent with the disclosure. The print substance container 510 may be analogous or similar to print substance container 100, 202, 304, and/or 408 as illustrated in FIGS. 1, 2, 3, and 4, respectively. For instance, the print substance container 510 may include an adjustable stop 540 and markings 513, among other components including those described herein.

As mentioned, the adjustable stop 540 may be adjustable to selectively permit an amount of translation of a piston relative to a housing. The amount of translation may be equal to a respective total number of pages and therefore provide an approximate amount of print substance (e.g., three-dimensional printing powder) from the adjustable print substance container to the imaging device 560.

For instance, the print substance container 510 may be used to fill or refill a reservoir connected to the fill port 562. That is, although not shown in FIG. 5, the imaging device 560 may include a corresponding reservoir connected to the fill port 562. As mentioned, the term “print substance container” may refer to a vessel, bottle, bag, box, carton, or other suitable receptacle for the transfer and/or containment of a print substance.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. Similar elements or components between different figures may be identified by the use of similar digits. For example, 114 may reference element “14” in FIG. 1, and a similar element may be referenced as 214 in FIG. 2. Elements illustrated in the various figures herein may be added, exchanged, and/or eliminated so as to provide a plurality of additional examples of the disclosure. In addition, the proportion and the relative scale of the elements provided in the figures are intended to illustrate the examples of the disclosure and should not be taken in a limiting sense.

The above specification, examples and data provide a description of the method and applications and use of the system and method of the present disclosure. Since many examples may be made without departing from the spirit and scope of the system and method of the present disclosure, this specification merely sets forth some of the many possible example configurations and implementations.

What is claimed:

1. An adjustable print substance container comprising:
a housing;
a piston disposed in the housing to translate relative to the housing;
a stop coupled to the housing or the piston;
markings disposed on the housing or the piston coupled to the stop, the markings corresponding to a plurality of a total number of pages; and
an adjustable stop coupled to the other of the housing or the piston, the adjustable stop being adjustable to selectively permit an amount of translation of the piston relative to the housing, the amount of translation being equal to a respective total number of pages of the plurality of the total number of pages.

2. The container of claim 1, wherein the respective total number of the pages corresponds to an approximate volume of print substance utilizable by an imaging device to generate the respective total number of the pages.

3. The container of claim 1, wherein the housing includes a plurality of notches.

4. The container of claim 3, wherein the adjustable stop further comprises an elongated member including an interface on a distal end of the elongated member to couple to be disposed in a notch of the plurality of notches.

5. The container of claim 1, including brackets extending from the housing, wherein the brackets include respective openings passing through the brackets, wherein an interior surface of the respective openings includes a threaded surface.

6. The container of claim 5, wherein the adjustable stop further comprises a rotatable adjustable stop to rotate in the threaded surface of the respective openings to translate along a portion of a length of the housing.

7. The container of claim 1, wherein the piston includes a threaded exterior surface, and wherein the adjustable stop comprises a nut to permit rotation and translation of the nut relative to the piston.

8. The container of claim 1, wherein the piston includes a threaded exterior surface, and wherein the adjustable stop comprises a fastener to couple to a thread of the threaded exterior surface.

9. The container of claim 1, wherein the stop comprises a fixed projection extending from a particular location on the housing, wherein the stop is positioned relative to the adjustable stop to limit an amount of downward translation of the piston relative to the housing.

10. An adjustable print substance container comprising:
a housing including:
markings corresponding to a plurality of a total number of pages disposed on an exterior surface of the housing;
a nozzle in fluidic communication with a volume defined by the housing; and
a stop;
a piston disposed in the housing to translate relative to the housing; and
an adjustable stop coupled to the housing, the adjustable stop being adjustable to selectively permit an amount of translation of the piston relative to the housing, the amount of translation being equal to a respective total number of pages of the plurality of the total number of pages.

11. The container of claim 10, wherein the nozzle further comprises an opening defined by the housing extending from the volume defined by the housing to an environment surrounding the adjustable print substance container.

12. The container of claim 11, wherein the stop further comprising a fixed projection at a second distal end of the housing opposite the first distal end of the housing.

13. A system comprising:
an imaging device including a fill port; and
adjustable print substance container including:
a housing including a plurality of markings corresponding to a plurality of a total number of pages, a nozzle, a stop, an internal volume defined by the housing, and a print substance disposed in the internal volume;
a piston disposed in a portion of the internal volume of the housing;
an adjustable stop coupled to the housing to, in combination with the stop, limit an amount of translation of the piston relative to the housing to a respective total number of pages of the plurality of the total number of pages; and
a nozzle to permit transfer of a volume of the print substance from the internal volume that corresponds to the respective total number of pages, via the fill port, to the imaging device.

14. The system of claim 13, wherein the respective total number of pages has a volume that is less than a volume of print substance in the internal volume of the adjustable print substance container.

15. The system of claim 13, wherein the print substance is a printing powder, wherein the printing powder includes toner, a three-dimensional printing powder, or combinations thereof.
